(19) United States
(12) Patent Application Publication
(10) Pub. No.: US 2019/0014737 A1
(43) Pub. Date: Jan. 17, 2019

(54) PET WALKER SAFETY ENCLOSURE

(71) Applicants: Albert G. Last, Brooklyn, NY (US); Carl J. Last, Landing, NJ (US)

(72) Inventors: Albert G. Last, Brooklyn, NY (US); Carl J. Last, Landing, NJ (US)

(21) Appl. No.: 15/650,740

(22) Filed: Jul. 14, 2017

(51) Int. Cl. A01K 1/00; A01K 1/02

(52) U.S. Cl. CPC A01K 1/0035; A01K 1/0236

(57) ABSTRACT

The purpose of the Pet Walker Safety Enclosure (PWSE) is to keep your pet in a safe enclosure while walking or stationary. The PWSE is a self-adjustable enclosure that will accommodate several pets or just one depending on your need. The PWSE can easily be adjusted in length, width and height with the click of several buttons. PWSE is made of several materials including plastic, metal, vinyl and rubber.

### CROSS-REFERENCE TO RELATED APPLICATIONS

Not Applicable.

The Pet Walker Safety Enclosure (PWSE) is an excellent way to train your pet in a safe environment and is an excellent exercise tool with you at the controls.

The PWSE provides your pet the opportunity to go where they were prevented from going before and the ability to go where every pet loves to go and have fun. The pet lover is given all the options in one that were not available before.

### BRIEF SUMMARY OF THE INVENTION

The purpose of the Pet Walker Safety Enclosure (PWSE) is to keep your pet in a safe enclosure while walking or stationary. The PWSE is a self-adjustable enclosure that will accommodate several pets or just one depending on your need. The PWSE can easily be adjusted in length, width and height with the click of several buttons. PWSE is made of several materials including plastic, metal, vinyl and rubber.

### BRIEF DESCRIPTION OF THE SEVERAL VIEWS OF THE DRAWINGS

FIG. 1 is a perspective view of the Pet Walker Safety Enclosure with numbered components;

FIG. 2 shows the detachable roller assembly;

FIG. 3 shows the adjustable rails with button locks;

FIG. 4 represents the snap on top;

FIG. 5 represents the detachable sand skis;

FIG. 6 represents the attachable accessory bag;

FIG. 7 represents the attachable flotation bottom.

### DETAILED DESCRIPTION OF THE INVENTION

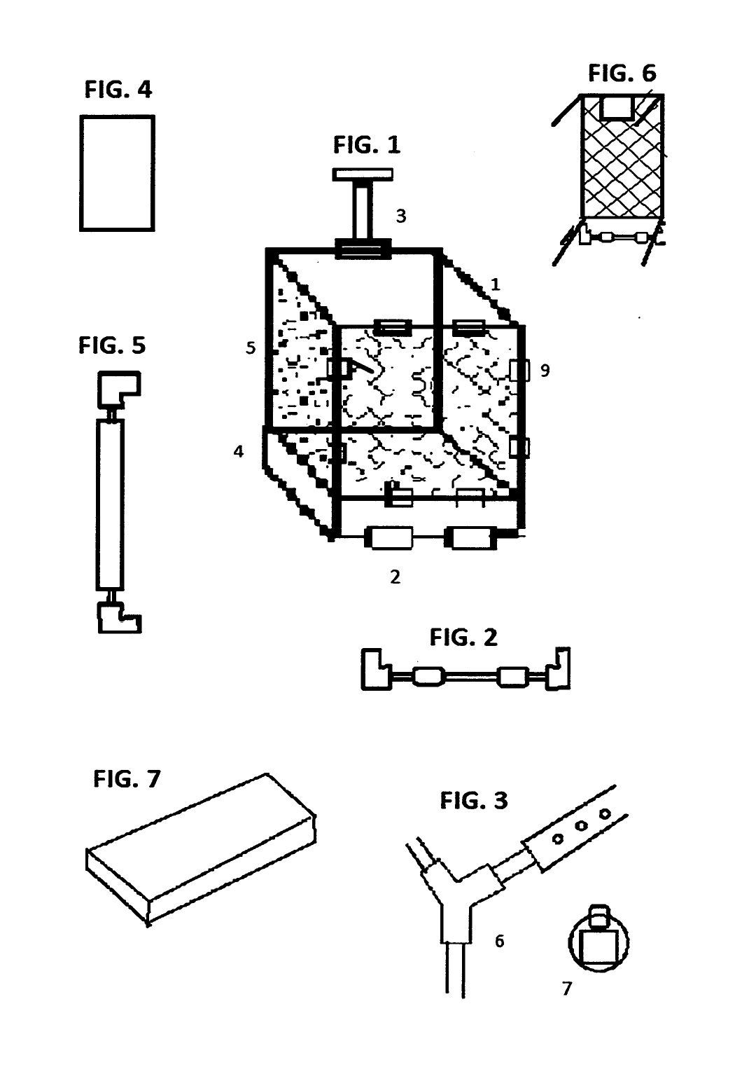

The PWSE (FIG. 1) has a rigid frame (1) that allows your pet to be walked on land with detachable push/pull handle (3). The roller assembly (2) provides mobility and unlike wheels allows instant turning at any angle quickly and smoothly. Enclosure fencing (5) is attached to the frame using Velcro straps (9).

Side guards (4) cover the gap beneath the frame.

The roller assembly (FIG. 2) is detachable to allow use of other accessories of the make the unit stationery.

The PWSE can easily be adjusted in length, width and height (FIG. 3) with the click of several buttons (6, 7).

Snap on sand skis (FIG. 5) for use at the beach or any sandy area make travel on sand like skiing on a mountain of snow.

An attachable accessory bag (FIG. 6) can be affixed to the PWSE to hold water, snacks, safety sprays, pick-up bags and any other items you want to bring. It is attached by utility clips.

The attachable safety floor can be inserted to act as a flotation device (FIG. 7) to keep your pet(s) safely afloat in water. It is easily snapped on to the bottom framework.

On land, your pet has open ground underneath to walk or poop safe from other animals (or people).

The PSWE is constructed of sturdy lightweight materials. I can be easily adjusted to allow for storage or car travel.

I claim:

1. The Pet Walker Safety Enclosure (PWSE) has a sturdy lightweight framework consisting of adjustable tubing with enclosure fencing and detachable roller assembly.

2. The removable handle assembly allows the PWSE to be pushed or pulled.

3. Accessories include attachable sand skis, accessory-bag, flotation bottom and snap on top cover.
